(19) United States
(12) Patent Application Publication
(10) Pub. No.: US 2015/0014964 A1
(43) Pub. Date: Jan. 15, 2015

(54) Ambulatory Assistance Device

(71) Applicant: Penta Mobility, Inc., Leominster, MA (US)

(72) Inventors: Joseph D. Antocci, Leominster, MA (US); Edward A. Kamens, Acton, MA (US)

(73) Assignee: Penta Mobility, Inc., Leominster, MA (US)

(21) Appl. No.: 14/167,642

(22) Filed: Jan. 29, 2014

Related U.S. Application Data
(60) Provisional application No. 61/758,539, filed on Jan. 30, 2013.

(51) Int. Cl. A61H 3/04; B62B 5/00; B60B 33/00

(52) U.S. Cl. CPC A61H 3/04; B60B 33/00; B62B 5/00; A61H 2201/0161
USPC 280/639; 280/47.34

(57) ABSTRACT

An ambulatory assistance device includes a base having a set of wheels the base configured to at least partially surround a patient's body to provide a maximum level of support along all possible force vectors. The base includes ballast to lower the center of gravity of the ambulatory assistance device. Furthermore, the ambulatory assistance device includes a frame assembly having a handle extending from the base. The handle is disposed at a distance between about two inches and three inches proximal to the center of gravity of the unit. This positioning of the handle, in combination with the positioning of the wheels of the base provides the ambulatory assistance device with a substantially stable design.

### RELATED APPLICATIONS

This patent application claims the benefit of U.S. Provisional Application No. 61/758,539, filed on Jan. 30, 2013, entitled, “Ambulatory Assistance Device,” the contents and teachings of which are hereby incorporated by reference in their entirety.

### BACKGROUND

A variety of ambulatory support devices, commonly known as walkers, are available for patients who have difficulty walking under their own power. For example, patients with limited mobility, such as patients who are recovering from various surgeries, who are physically weak, or are mentally disabled typically use these types of devices.

To aid in patient mobility, conventional ambulatory support devices can be configured in a variety of ways. For example, typical ambulatory support devices can include a frame having legs or wheels that contact the floor.

### SUMMARY

Conventional ambulatory support devices suffer from a variety of deficiencies. For example, typical ambulatory support devices lack front-to-back stability and can become unstable without much effort by the user. In the event a patient were to apply his weight unevenly on the support device, such as by concentrating his body weight on front-right or front-left corners of the support, the device can tip and cause a fall and subsequent injury to the already disabled patient. Additionally, conventional wheeled ambulatory support devices can be difficult to maneuver in a home or clinical setting due to the positioning or configuration of the wheels.

By contrast to conventional ambulatory support devices, embodiments of the present innovation relate to an ambulatory assistance device. In one arrangement, the ambulatory assistance device includes a base having a set of wheels, the base configured to at least partially surround a patient's body to provide a maximum level of support along force vectors applied along a variety of directions. Additionally, in one arrangement, the base includes ballast to lower the center of gravity of the ambulatory assistance device. In one arrangement, the ballast is configured as a combination of a load integrally formed with the base along with a user-selected weight. The user selected weight allows the user to tailor the overall ballast associated with the ambulatory assistance device based upon the user's weight and/or other physical attributes. Furthermore, the ambulatory assistance device includes a frame assembly having a handle extending from the base. The handle is disposed at a distance between about two inches and three inches proximal to the center of gravity of the unit. This positioning of the handle, in combination with the positioning of the wheels of the base provides the ambulatory assistance device with a relatively large amount of stability in use.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a perspective view of an ambulatory assistance device, according to one arrangement.

FIG. 2 illustrates a side view of the ambulatory assistance device of FIG. 1, according to one arrangement.

FIG. 3 illustrates a front view of the ambulatory assistance device of FIG. 1, according to one arrangement.

FIG. 4 illustrates a top view of the ambulatory assistance device of FIG. 1, according to one arrangement.

FIG. 5 illustrates a bottom view of the ambulatory assistance device of FIG. 1, according to one arrangement.

FIG. 6 illustrates a top sectional view of the ambulatory assistance device of FIG. 1, according to one arrangement.

FIG. 7 illustrates a side sectional view of the ambulatory assistance device of FIG. 1, according to one arrangement.

FIG. 8 illustrates a perspective view of the ambulatory assistance device of FIG. 1, having a handle disposed in a collapsed position relative to the base, according to one arrangement.

FIGS. 9 and 10 illustrate an ambulatory assistance device, according to one arrangement, in an expanded position and in a collapsed position, respectively.

### DETAILED DESCRIPTION

Embodiments of the present innovation relate to an ambulatory assistance device. In one arrangement, the ambulatory assistance device includes a base having a set of wheels, the base configured to at least partially surround a patient's body to provide a level of support along all possible force vectors applied along a variety of directions. Additionally, in one arrangement, the base includes ballast to lower the center of gravity of the ambulatory assistance device. In one arrangement, the ballast is configured as a combination of a load integrally formed with the base along with a user-selected weight. The user selected weight allows the user to tailor the overall ballast associated with the ambulatory assistance device based upon the user's weight and/or other physical attributes. Furthermore, the ambulatory assistance device includes a frame assembly having a handle extending from the base. The handle is disposed at a distance between about two inches and three inches proximal to the center of gravity of the unit. This positioning of the handle, in combination with the positioning of the wheels of the base provides the ambulatory assistance device with a substantially stable design a relatively large amount of stability in use.

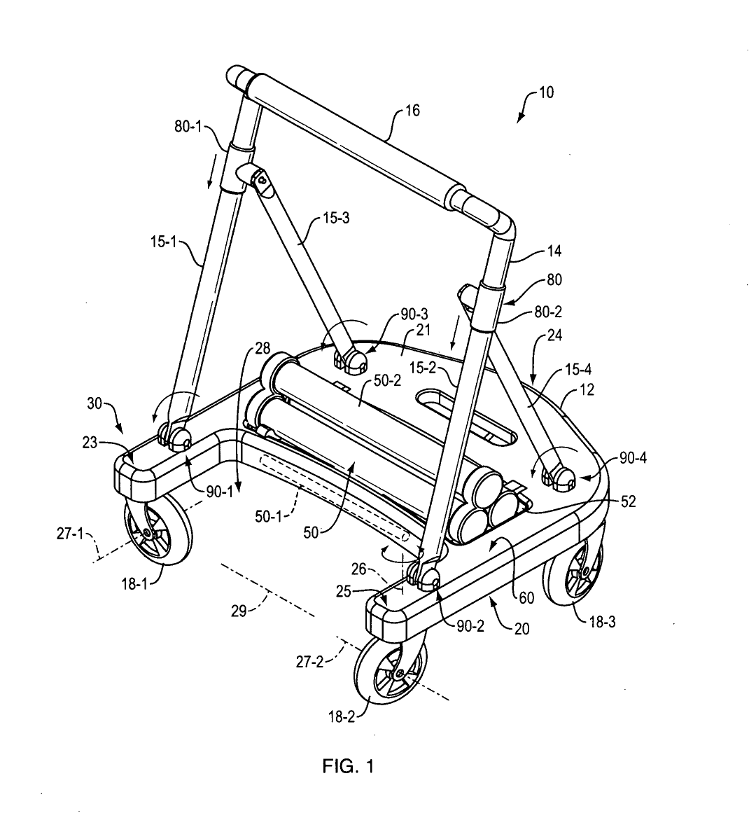

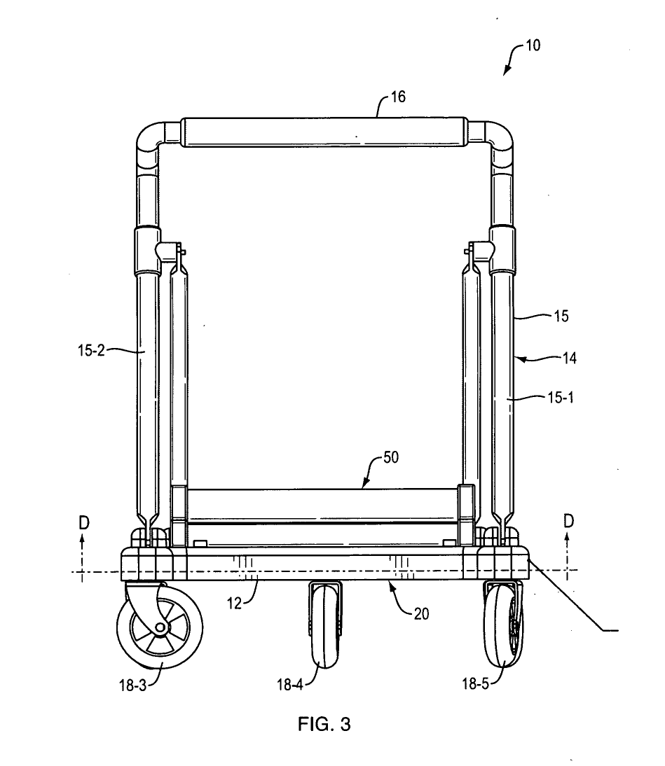

FIGS. 1-8 illustrate an ambulatory assistance device 10 according to one arrangement. The ambulatory assistance device includes a base 12, and a frame assembly 14 having a frame 15 and a handle 16 coupled to the base 12.

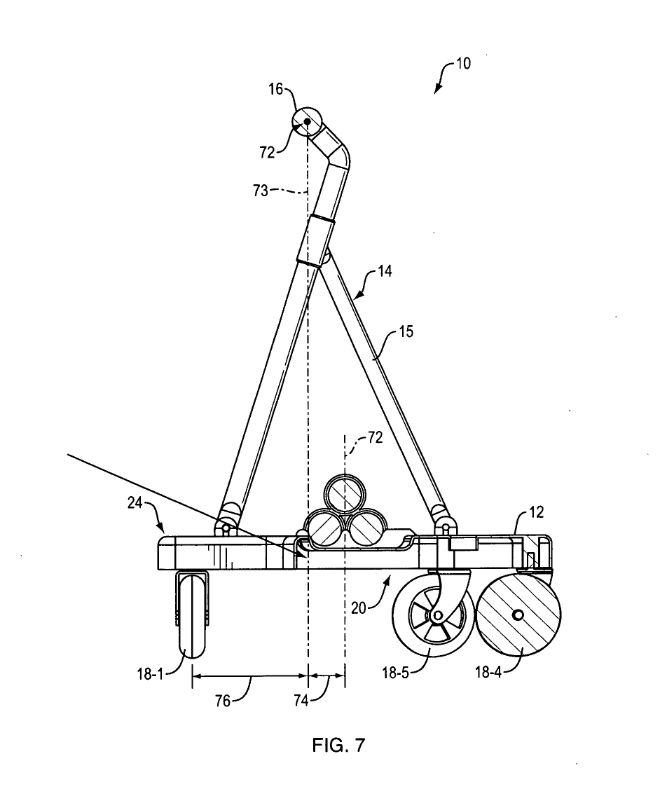

As best shown in FIG. 1, the base 12 is configured to distribute a user's body weight about the user and to the ambulatory assistance device 10 to minimize the ability for the user to tip the device 10. For example, the base 12 includes a body portion 21 and first and second side portions 23, 25 that extend from a proximal portion 30 of the base 12. The body portion 21 and first and second side portions 23, 25 define a cut-out or channel 28 at the proximal portion 30 of the base 12. The channel 28 is configured to allow the user to position his body in relatively close proximity to a center of gravity 73 of the device 10, as illustrated in FIG. 7.

For example, in use, and with particular reference to FIG. 1, when a user grasps the handle 16 of the ambulatory assistance device 10, the user can position his body within the channel 28 and adjacent to the center of gravity 73. With such positioning, first and second side portions 23, 25 and first and second wheels 18-1, 18-2 of the base 12 extend about the left and right sides of the user to substantially surround the user. Accordingly, as a user applies his body weight onto the frame 15, based upon the user's positioning within the channel 28, the frame 15 distributes at least a portion of the user's body weight to the body portion 21 of the base 12 and to the first and second side portions 23, 25 to provide vertical and lateral stability of the device 10, thereby minimizing tipping of the device 10 along its vertical or longitudinal axes.

The base 12 can include ballast or weight 50 configured to lower the center of gravity of the ambulatory assistance device 10. The amount of ballast 50 carried by the base 12 can be based upon weight of user. For example, the ballast 50 can have a weight between about 10 pounds and 25 pounds.

The base 12 can be configured to carry the ballast 50 in a variety of ways. In one arrangement, as indicated in FIG. 1, a first ballast portion 50-1 can be integrally formed with the base 12 and a second ballast portion 50-2 incrementally added to, and selectively carried by, the base 12. For example, the base 12 defines a depression or basket 52 configured to hold the second ballast portion 50-2. In use, the user can add various amounts of ballast 50-2 to the basket 52 depending upon the weight of the user to minimize the ability of the user to tip the device 10 during operation. In one arrangement, the base 12 is preconfigured or integrally formed with a specific ballast portion 50-1 based upon the weight of the particular user of the device 10. In such an arrangement, the user would not be required to add the second ballast portion 50-2 to the base 12 prior to operation. In one arrangement, the base 12 does not include an integrally formed first ballast portion 50-1. Accordingly, the second ballast portion 50-2 can be added to the basket 52 prior to use to minimize the ability of the user to tip the device 10 during operation. In another arrangement, the base 12 lacks a ballast component and various amounts of ballast 50-2 can be selectively added to the device 90, depending upon the weight of the user, to maintain stability of the device 10 during use.

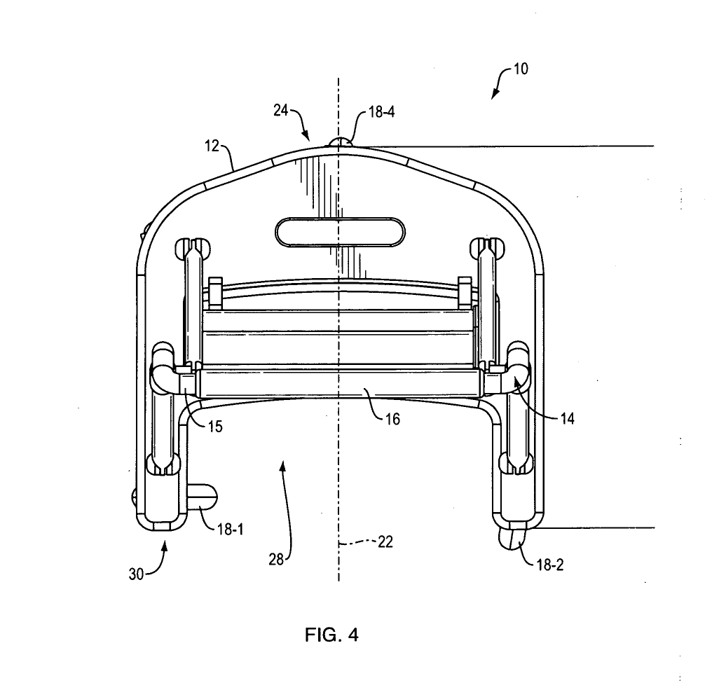

The base 12 includes a set of wheels 18 disposed on a first side 20 of the base 12. In one arrangement, the set of wheels 18 includes a set of five wheels 18-1 through 18-5. While the wheels 18-1 through 18-5 can be disposed at a variety of locations on the base 12, in one arrangement, wheels 18-1, 18-2, 18-3, and 18-5 are generally disposed at the corresponding corners of the base 12 while wheel 18-4 is substantially centrally aligned with a longitudinal axis 22 of the base 12, as indicated in FIG. 4, and disposed at a front or proximal portion 24 of the base 12. For example, the first wheel 18-1 is disposed at the end of the first side portion 23 of the base 12 and the second wheel 18-2 is disposed at the end of the second side portion 25 of the base 12. Further, the third wheel 18-3 is disposed at the first distal corner of the body portion 21, the fourth wheel 18-4 is disposed at substantially the distal center of the body portion 21, and the fifth wheel 18-5 is disposed at a second distal corner of the body portion 21. Additionally, while the wheels 18 can be configured in a variety of sizes, in one arrangement, each of the wheels 18 are configured with about a five inch diameter. In use, the positioning of the wheels 18-1 through 18-5 relative to the base 12 distributes a patient's body weight in a substantially even manner relative to the floor.

In one arrangement, to provide a user with the ability to maneuver the ambulatory assistance device 10 in a variety of settings, one or more of the wheels 18 can be configured as swivel wheels which can rotate 360 degrees about a longitudinal axis 26, as illustrated in FIG. 1. One or more of the swivel wheels can include a swivel lock mechanism (not shown) to fix the relative rotational orientation of the wheel about the longitudinal axis 26 and relative to the base 12 and to configure the wheels 18 as non-swivel wheels. For example, the two rear-most wheels 18-1, 18-2 can include the lock mechanism to secure the positioning of the wheels 18-1, 18-2 such that each of the wheel axes 27-1, 27-2 substantially aligned along a vertical axis 29 and the wheels 18-3 through 18-5 are configured as swivel wheels. In another example, the center wheel 18-4 is configured as a non-swivel wheel while wheels 18-1, 18-2, 18-3, and 18-5 are configured as swivel wheels. With either configuration, the presence of one or more non-swivel wheels as described allows for easier tracking of the device 10 in use. Such a configuration is typically necessary for stroke patients who have asymmetrical strength.

In one arrangement, one or more of the wheels 18 can include a braking element (not shown). For example, each wheel 18-1 through 18-5 can include a braking element. In another example, the rear wheels 18-1 and 18-2 can each include a braking element. The braking element is configured to lock the positioning of the wheel 18 relative to an axis of rotation 27 to minimize or prevent motion of the device 10.

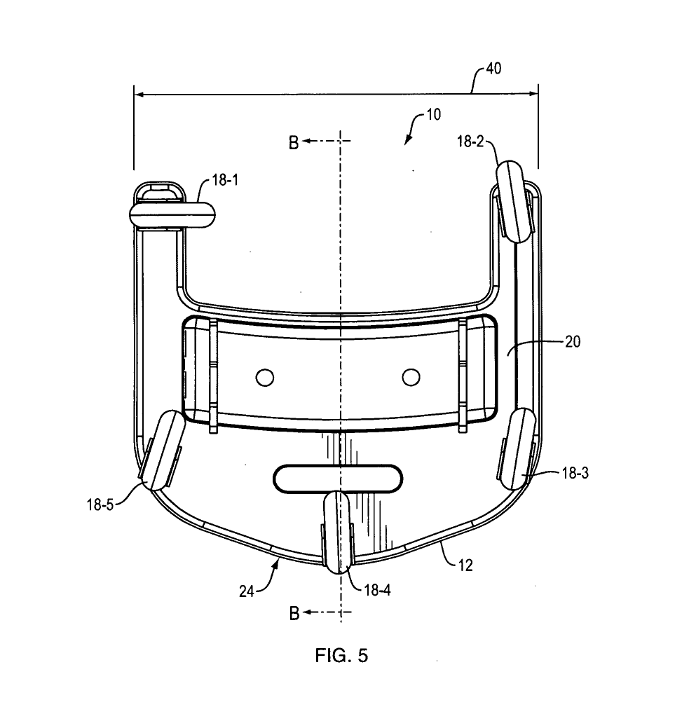

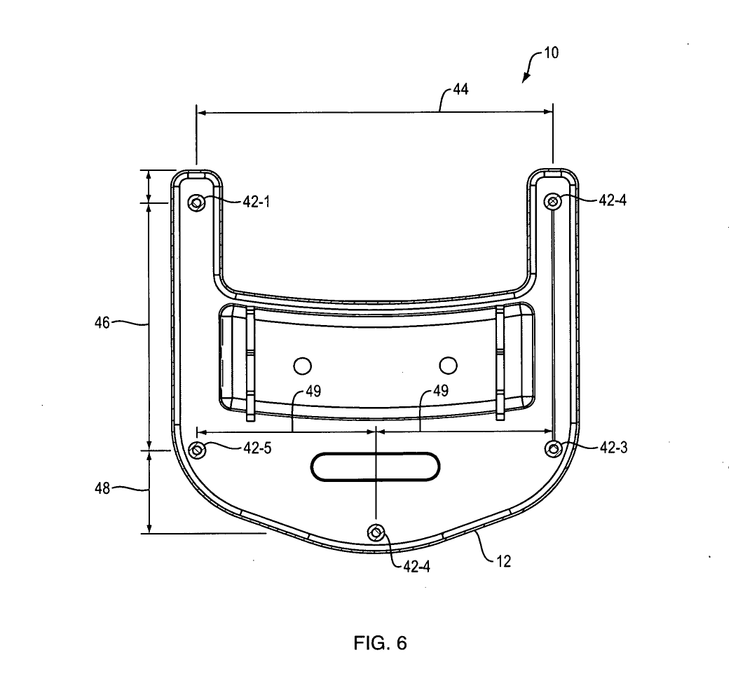

The positioning of the wheels 18 on the base 12 can also add to the stability of the device 10. For example, with reference to FIG. 5, assume the base 12 defines a width 40 of between about 23 inches and 26.5 inches. With additional reference to FIG. 6, the mounting locations 42-1, 42-4 for the first and fourth wheels 18-1, 18-4, respectively, and the mounting locations 42-5, 42-3 for the fifth and third wheels 42-5, 42-3, respectively, can be disposed at a distance 44 of between about 20 inches and 22 inches apart. Furthermore, the mounting locations 42-1, 42-5 for the first and fifth wheels 18-1, 18-5, respectively, and the mounting locations 42-3, 42-4 for the third and fourth wheels 42-3, 42-4, respectively, can be disposed at a distance 44 of between about 15 inches and 20.5 inches apart. Additionally, the mounting location 42-4 of the fourth wheel 18-4 can be disposed at a distance 48 of between about 4.5 inches and 5.5 inches from the axis of rotation of the second and third wheels and can be disposed at a distance 49 of about 4.5 inches from each of the mounting locations 42-5, 42-3 for the fifth and third wheels 42-5, 42-3, respectively.

The frame 15 extends from a second side 60 of the base 12 and is configured to distribute weight applied from a user to the base 12. For example, with reference to FIG. 1, the frame 15 includes a first frame portion 15-1 and a second frame portion 15-2 coupled to the first and second side portions 23, 25, respectively. The frame 15 also includes a third frame portion 15-3 and a fourth frame portion 15-4 coupled to the respective distal corners of the body portion 21 of the base 12. In one arrangement the frame portions 15-1 through 15-4 define a substantially A-frame shaped structure. In use, as a user applies his body weight to the frame 15 via the handle 16, the frame portions 15-1 through 15-4 direct the load toward the corners of the base 12, thereby minimizing the user's ability to tip the device 10.

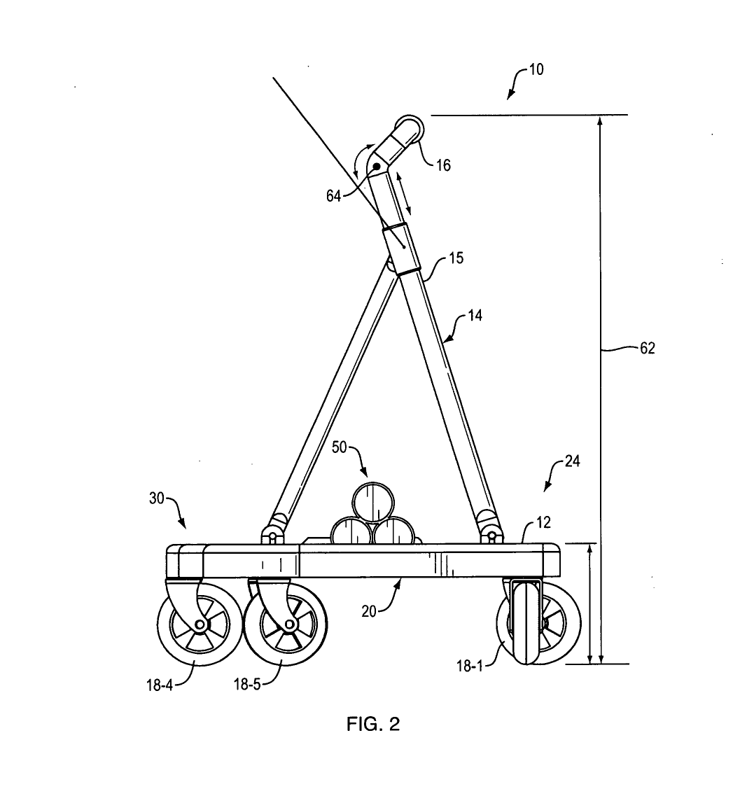

The frame 15 is also configured to position the handle 16 at a user defined height. For example, with reference to FIG. 2, the frame 15 positions the handle 16 at a distance 62 of between about 30 inches and 35 inches from a reference surface, such as a floor. In one arrangement, this distance 62 can be adjusted to optimize of height of the handle 16 for a variety of users. For example, with continued reference to FIG. 2, the position of the handle 16 can be linearly extended or compressed relative to the frame 15, such as via a telescoping mechanism. In another example, the handle 16 is configured to pivot relative to the frame 16, such as via a hinge 64, to aid in the height adjustment.

The frame 15 further positions the handle 16 laterally relative to the center of gravity 73 of the device 10 and relative to the wheel layout to provides the device 10 with a level of stability. With specific reference to FIG. 7, a longitudinal axis 72 of the handle 16 is disposed at a distance 74 of between about two inches and three inches from the center of gravity 73 of the device 10. Additionally, the longitudinal axis 72 of the handle 16 is disposed at a distance 76 of between about five inches and seven inches from the mounting locations 42-1, 42-4 for the first and fourth wheels 18-1, 18-4, respectively. Such positioning minimizes the length of a moment arm between the handle 16 and the rear portion 24 of the base 12, thereby minimizing the user's ability to lift or tip the device 10.

With such an arrangement, the device 10 provides an improved stability relative to conventional walkers or other ambulatory assist devices. For example, the relative positioning of handle 16, ballast 50, front wheels 18-3 through 18-5, and rear wheels 18-1, 18-2 provides front-to-back and side-to-side stability to device 10 which limits a user's ability to tip the device. Additionally, the five wheel swivel design is much more maneuverable in a home setting relative to conventional walkers, in particular with respect to a user gaining access and egress to toilets. Furthermore, the device 10 can be used to provide a level of physical therapy to a patient. For example, a relatively large group of patients are not physically strong enough or mentally stable enough (e.g., Dementia patients) to utilize a traditional walker or support but are also not frail enough for a wheelchair. The device 10 allows this type of patient with the opportunity to get stronger using this more stable platform and free himself from the necessity for a wheelchair.

In one arrangement, the device 10 is configured as at least partially collapsible to allow for relatively easy be transport. For example, the frame 15 and handle 16 can be removed or disassembled relative to the base 12. In another example, with reference to FIG. 1, the frame 15 can fold relative to the base 12. For example, returning to FIG. 1, the first frame portion 15-1 is hingedly coupled to the first side portion 23 of the base 12 and the second frame portion 15-2 is hingedly coupled to the second side portion 25 of the base 25. Further, the third frame portion 15-2 is moveably coupled to the first frame portion 15-1, such as via a collar 80-1 of a set of collars 80, and is hingedly coupled to a first distal corner of the body portion 21 of the base 12. Additionally, the fourth frame portion 15-4 is moveably coupled to the second frame portion 15-2, such as via a collar 80-2 of a set of collars 80, and is hingedly coupled to a second distal corner of the body portion 21 of the base 12.

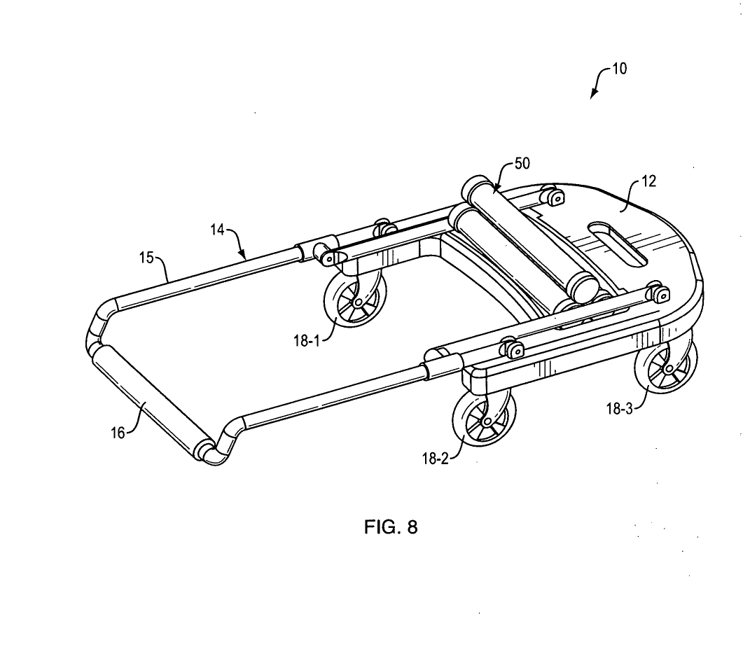

In use, the frame assembly 14 can the frame assembly 14 includes is disposed in an extended position relative to the base 12. When ready for transport, a user can release a locking mechanism (not shown) between the frame assembly 14 and the base 12. Such release allows the first frame portion 15-1, the second frame portion 15-2, the third frame portion 15-3, and the fourth frame portion 15-4 to rotate about respective hinges 90-1 through 90-4 relative to the base 12 and causes the set of collars 80 to translate relative to the first and second frame portions 15-1, 15-2. Such motion allows the frame assembly 14 to rotate relative to the base 12 between an extended position, as shown in FIG. 1, and a collapsed position, as shown in FIG. 8.

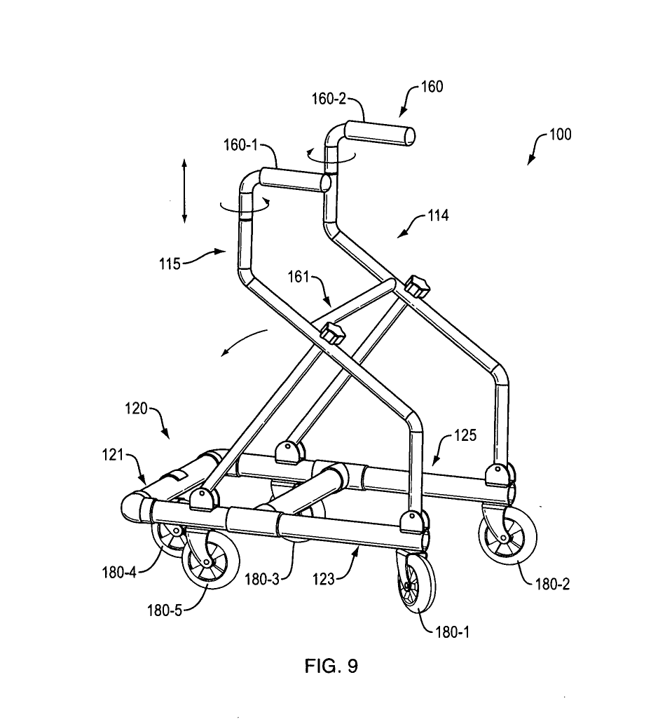

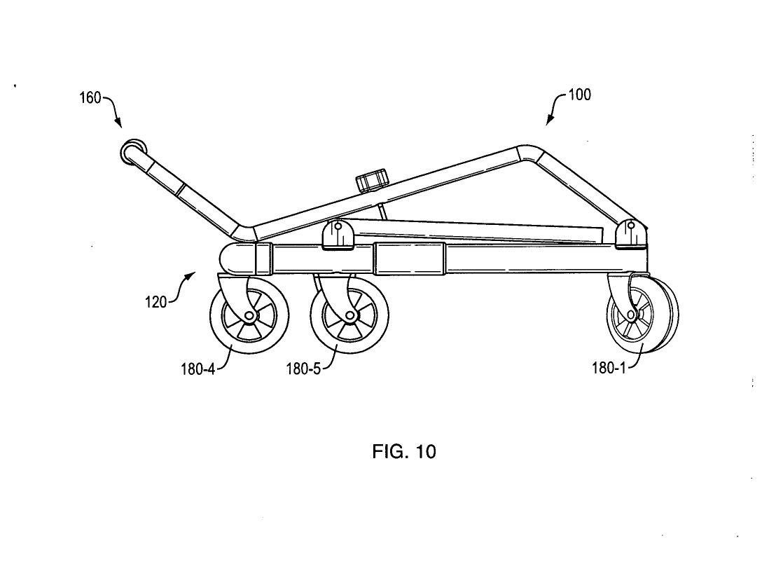

As indicated above, the ambulatory assistance device 10 can include ballast to lower the center of gravity of the device. In one arrangement, as illustrated in FIGS. 9 and 10, an ambulatory assistance device 100 is configured with a relatively lightweight frame structure, such as a tubular frame structure, Such a configuration reduces the overall weight of the device 100, thereby allowing the device 100 to be transported in a relatively easy manner.

For example, the ambulatory assistance device 100 includes a base 120 having a body portion 121, a first side portion 123 and a second side portion 125 formed from a relatively lightweight tubular material, such as a PVC tube material. The base 120 includes a set of five wheels 180-1 through 180-5 and a frame assembly 114 formed from a relatively lightweight tubular material, such as a tubular steel material. In one arrangement, the frame assembly 114 includes a frame 115 having two sets of handles. For example the frame 115 includes a first set of positionally adjustable handles 160, such as first and second handles 160-1 and 160-2. The handles 160 are configured to be both rotationally and longitudinally (height) adjusted relative to the frame 115 to accommodate a user. The frame 115 also includes a substantially non-adjustable cross bar grip 161.

In one arrangement, the ambulatory assistance device 100 lacks an integrally formed ballast, thereby minimizing the overall weight of the device 100. In another arrangement, the ambulatory assistance device 100 includes ballast, such as steel shot, if used, disposed within the tubular structure of the base 120.

With the base and frame manufactured from a relatively lightweight tubular material, the ambulatory assistance device 100 is relatively lightweight, thereby allowing the ambulatory assistance device 100 to be easily down from an expanded position, as shown in FIG. 9, to a collapsed position, as shown in FIG. 10, and transported. Additionally, with such a configuration, the ambulatory assistance device 100 can be utilized by patients with relatively weak lower extremities and normal upper body strength. Patients who often fall into this category have a variety of weight bearing abilities with normal upper extremity strength including patients who have suffered from stroke, acute injury/fracture, recent total joint replacements, and amputees. The ambulatory assistance device 100 will allow patients to exert and utilize their full arm strength without the concern of tipping the walker.

While various embodiments of the innovation have been particularly shown and described, it will be understood by those skilled in the art that various changes in form and details may be made therein without departing from the spirit and scope of the innovation as defined by the appended claims.

For example, as described above, the rear wheels can be configured with locking mechanisms. Such description is by way of example only. In one arrangement, all of the wheels 18 or associated casters can include swivel locks. With such a configuration, the device 10 can have limited maneuverable with respect to steering, but can provide relatively easier tracking.

As indicated above, the handle 16 is configured to be laterally and rotationally positioned relative to the frame. Such description is by way of example only. -In one arrangement, the handle 16 is fixed to the frame and not adjustable.

In another example, the handle 16 can be configured with a variety of geometries. For example, as illustrated the handle 16 can extend longitudinally between first and second frame assembly elements 15-1, 15-2 as a cross bar. With such a configuration, the handle 16 provides leaning support for users, such as patients with spinal stenosis and allows for attachment of user accessories, such as a basket to carry a variety of user items. In one arrangement, the handle 16 can be configured with a variety of gripping surfaces. In one arrangement the handle 16 includes a relatively soft, textured grip material disposed on the outer surface to provide a relatively secure grip for weak patients.

As indicated above, the handle 16 is disposed at a distance between about two inches and three inches proximal to the center of gravity of the unit. Such description is by way of example only. In one arrangement, the handle 16 is positioned substantially at the center of gravity 73 of the device 10, within a range of about +/− one inch. Such placement can further add to the stability of the device 10 to minimize or limit the user's ability to tip the device 10 over during use.

What is claimed is:

1. An ambulatory assistance device, comprising:
a base;
a set of wheels coupled to the base; and
a frame assembly extending from the base, the frame assembly having a frame and a handle, the handle defining a longitudinal axis disposed at a distance of between two inches and three inches relative to a center of gravity of the ambulatory assistance device.

2. The ambulatory assistance device of claim 1, wherein the base comprises:
a body portion;
a first side portion extending from a proximal end of the body portion; and
a second side portion extending from a proximal end of the body portion, the body portion, first distal end, and second distal end defining a channel configured to provide positioning of a user's body in proximity to the center of gravity of the ambulatory assistance device.

3. The ambulatory assistance device of claim 2, wherein the set of wheels comprises:
a first wheel coupled to the first side portion of the base;
a second wheel coupled to the second side portion of the base;
a third wheel coupled to a first distal corner of the body portion;
a fourth wheel coupled substantially at a distal center of the body portion; and
a fifth wheel coupled to a second distal corner of the body portion.

4. The ambulatory assistance device of claim 3, wherein at least one wheel of the set of wheels is a swivel wheel configured to rotate 360 degrees about a longitudinal axis relative to the base.

5. The ambulatory assistance device of claim 4, wherein the first wheel, the second wheel, the third wheel, and the fifth wheel are configured as swivel wheels and the fourth wheel is configured as a non-swivel wheel.

6. The ambulatory assistance device of claim 4, wherein the third wheel, the fourth wheel, and the fifth wheel are configured as swivel wheels and the first wheel and the second wheel are configured as non-swivel wheels.

7. The ambulatory assistance device of claim 3, wherein:
the first wheel and the fourth wheel are disposed on the base at a distance of between about 20 inches and 22 inches apart;
the fifth wheel and the third wheel are disposed on the base at a distance of between about 20 inches and 22 inches apart;
the first wheel and the fifth wheel are disposed on the base at a distance of between about 15 inches and 20.5 inches apart;
the third wheel and the fourth wheel are disposed on the base at a distance of between about 15 inches and 20.5 inches apart;
the fourth wheel is disposed at a distance of between about 4.5 inches and 5.5 inches from an axis of rotation of the second wheel and the third wheel; and
the fourth wheel is disposed at a distance of about 4.5 inches from each of the fifth wheel and the third wheel.

8. The ambulatory assistance device of claim 2, wherein the frame comprises:
a first frame portion coupled to the first side portion of the base;
a second frame portion coupled to a second side portion of the base;
a third frame portion coupled between the first frame portion and a first distal corner of the body portion of the base; and
a fourth frame portion coupled between the second frame portion and a second distal corner of the body portion of the base.

9. The ambulatory assistance device of claim 8, wherein:
the first frame portion is hingedly coupled to the first side portion of the base;
the second frame portion is hingedly coupled to the second side portion of the base;
a third frame portion is moveably coupled to the first frame portion and is hingedly coupled to the first distal corner of the body portion of the base; and
the fourth frame portion is moveably coupled to the second frame portion and is hingedly coupled to the second distal corner of the body portion of the base,
the first frame portion, the second frame portion, the third frame portion, and the fourth frame portion configured to rotate relative to the base and the third frame portion and the fourth frame portion configured to translate relative to the respective first frame portion and second frame portion, when the frame assembly is positioned between an extended position and a collapsed position.

10. The ambulatory assistance device of claim 1, further comprising ballast carried by the base.

11. The ambulatory assistance device of claim 10, wherein the ballast is integrally formed with the base.

12. The ambulatory assistance device of claim 10, wherein the ballast is selectively carried by the base.

13. An ambulatory assistance device, comprising:
a base comprising:
a body portion,
a first side portion extending from a proximal end of the body portion, and
a second side portion extending from a proximal end of the body portion, the body portion, first distal end, and second distal end defining a channel configured to provide positioning of a user's body in proximity to the center of gravity of the ambulatory assistance device;
a set of five wheels coupled to the base, the set of five wheels comprising:
a first wheel coupled to the first side portion of the base,
a second wheel coupled to the second side portion of the base,
a third wheel coupled to a first distal corner of the body portion,
a fourth wheel coupled substantially at a distal center of the body portion, and
a fifth wheel coupled to a second distal corner of the body portion; and
a frame assembly extending from the base, the frame assembly having a frame and a handle, the frame assembly configured to distribute weight, applied to the handle, to the base.

14. An ambulatory assistance device of claim 13, wherein the handle defines a longitudinal axis disposed at a distance of between two inches and three inches relative to a center of gravity of the ambulatory assistance device.

15. The ambulatory assistance device of claim 13, wherein at least one wheel of the set of wheels is a swivel wheel configured to rotate 360 degrees about a longitudinal axis relative to the base.

16. The ambulatory assistance device of claim 15, wherein the first wheel, the second wheel, the third wheel, and the fifth wheel are configured as swivel wheels and the fourth wheel is configured as a non-swivel wheel.

17. The ambulatory assistance device of claim 15, wherein the third wheel, the fourth wheel, and the fifth wheel are configured as swivel wheels and the first wheel and the second wheel are configured as non-swivel wheels.

18. The ambulatory assistance device of claim 13, wherein:
the first wheel and the fourth wheel are disposed on the base at a distance of between about 20 inches and 22 inches apart;
the fifth wheel and the third wheel are disposed on the base at a distance of between about 20 inches and 22 inches apart;
the first wheel and the fifth wheel are disposed on the base at a distance of between about 15 inches and 20.5 inches apart;
the third wheel and the fourth wheel are disposed on the base at a distance of between about 15 inches and 20.5 inches apart;
the fourth wheel is disposed at a distance of between about 4.5 inches and 5.5 inches from an axis of rotation of the second wheel and the third wheel; and
the fourth wheel is disposed at a distance of about 4.5 inches from each of the fifth wheel and the third wheel.

19. The ambulatory assistance device of claim 13, wherein the frame comprises:
a first frame portion coupled to the first side portion of the base;
a second frame portion coupled to a second side portion of the base;
a third frame portion coupled between the first frame portion and a first distal corner of the body portion of the base; and
a fourth frame portion coupled between the second frame portion and a second distal corner of the body portion of the base.

20. The ambulatory assistance device of claim 19, wherein:
the first frame portion is hingedly coupled to the first side portion of the base;
the second frame portion is hingedly coupled to the second side portion of the base;
a third frame portion is moveably coupled to the first frame portion and is hingedly coupled to the first distal corner of the body portion of the base; and
the fourth frame portion is moveably coupled to the second frame portion and is hingedly coupled to the second distal corner of the body portion of the base,
the first frame portion, the second frame portion, the third frame portion, and the fourth frame portion configured to rotate relative to the base and the third frame portion and the fourth frame portion configured to translate relative to the respective first frame portion and second frame portion, when the frame assembly is positioned between an extended position and a collapsed position.
